(19) United States
(12) Patent Application Publication
(10) Pub. No.: US 2013/0195662 A1
(43) Pub. Date: Aug. 1, 2013

(54) TRANSMISSION STRUCTURE OF MAIN PROPELLER CLAMPING SEAT AND SWASHPLATE OF REMOTE-CONTROLLED HELICOPTER

(71) Applicant: Ta Sen TU, Taichung City (TW)

(72) Inventor: Ta Sen TU, Taichung City (TW)

(21) Appl. No.: 13/358,788

(22) Filed: Jan. 26, 2012

(51) Int. Cl. B64C 27/605

(52) U.S. Cl. 416/114

(57) ABSTRACT

The present invention relates to a transmission structure of a main propeller clamping seat and a swashplate of a remote-controlled helicopter. The main propeller clamping seat includes a pair of connection blocks at two ends thereof. The swashplate includes a pair of link rods which are connected with the pair of connection blocks of the main propeller clamping seat. The pair of link rods each has a pivot axle and an axle bolt. The axle bolt is inserted through the pivot axle and connected to the relative connection block. Through the link rods and the pivot axles, the main propeller clamping seat and the swashplate are direct driven to control the main propeller clamping seat and the angle of the wings quickly and precisely.

### BACKGROUND OF THE INVENTION

1. Field of the Invention

The present invention relates to a transmission structure of a main propeller clamping seat and a swashplate of a remote-controlled helicopter, and more particularly to a transmission structure which can be direct driven to control the angle of the main propeller clamping seat quickly and precisely.

2. Description of the Prior Art

As shown in FIG. 1, a conventional remote-controlled helicopter comprises a main propeller clamping seat 10. Two wings 11 are connected to two ends of the main propeller clamping seat 10. A driving shaft 12 is connected to the main propeller clamping seat 10. A swashplate 13 and a plurality of link seats 15, 16 are fitted on the driving shaft 12. The swashplate 13 comprises a main control rod 14. The main control rod 14 is connected with a motor for controlling the swashplate 13 to be moved up and down and tilted. The swashplate 13 and the link seats 15, 16 are connected by a link rod 17. The main propeller clamping seat 10 comprises a connection plate 101 to connect a link rod 18 and the link seat 15. Through the link rods 17,18 and the link seats 15, 16, the swashplate 13 can be moved to tilt the main propeller clamping seat 10, namely, to control the angle of inclination of the wings 11. The conventional remote-controlled helicopter has some drawbacks. The plurality of link rods 17,18 and the plurality of link seats 15, 16 are required. The structure is complicated and the cost is high because of many parts, and it may malfunction with ease. Through the complicated parts to drive, the transmission speed is low and the error may be great. Accordingly, the inventor of the present invention has devoted himself based on his many years of practical experiences to solve these problems.

### SUMMARY OF THE INVENTION

The primary object of the present invention is to provide a transmission structure of a main propeller clamping seat and a swashplate of a remote-controlled helicopter. The main features of the present invention are that (1) a link rod is connected between a main propeller clamping seat and a swashplate, forming “direct transmission” so that the control is quicker and precise and the cost is lowered (2) a pivot axle and a connection block are connected between the link rod and the main propeller clamping seat, which are endurable and stable for transmission.

### BRIEF DESCRIPTION OF THE DRAWINGS

FIG. 1 is a perspective view of a conventional remote-controlled helicopter;

FIG. 2 is an exploded view according to a preferred embodiment of the present invention;

FIG. 3 is a perspective view according to the preferred embodiment of the present invention;

FIG. 4 is a schematic view showing that the preferred embodiment of the present invention is tilted; and

FIG. 5 is a schematic view showing that the preferred embodiment of the present invention is moved up and down.

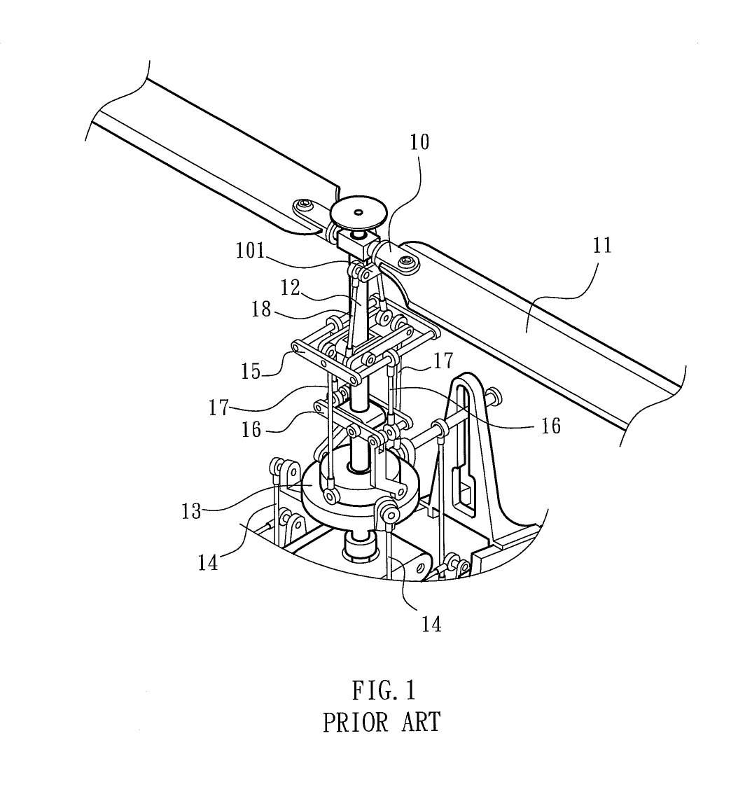

### DETAILED DESCRIPTION OF THE PREFERRED EMBODIMENTS

Embodiments of the present invention will now be described, by way of example only, with reference to the accompanying drawings.

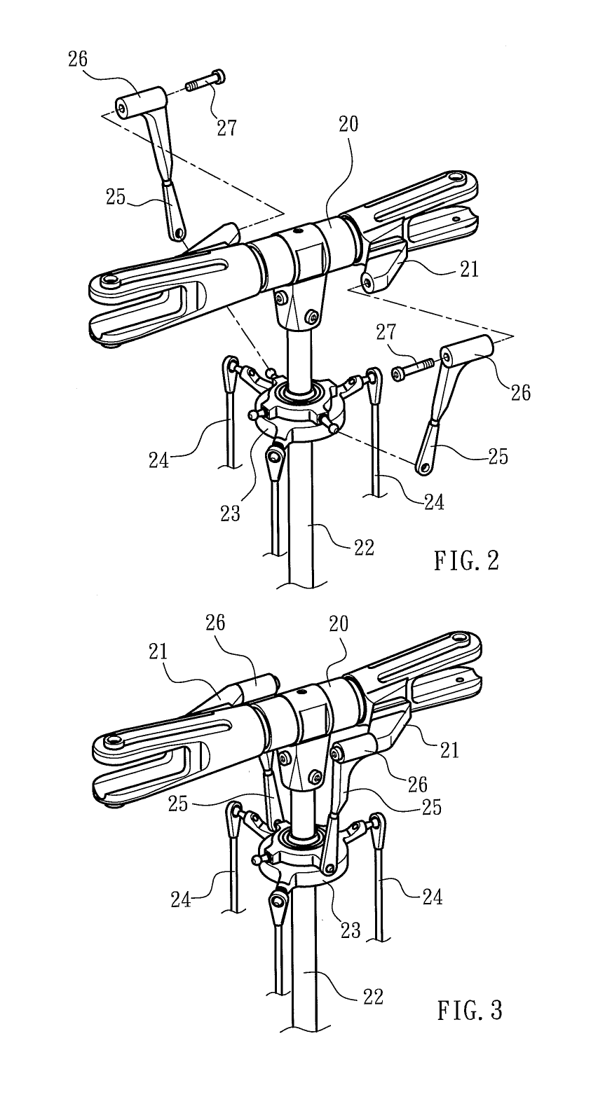

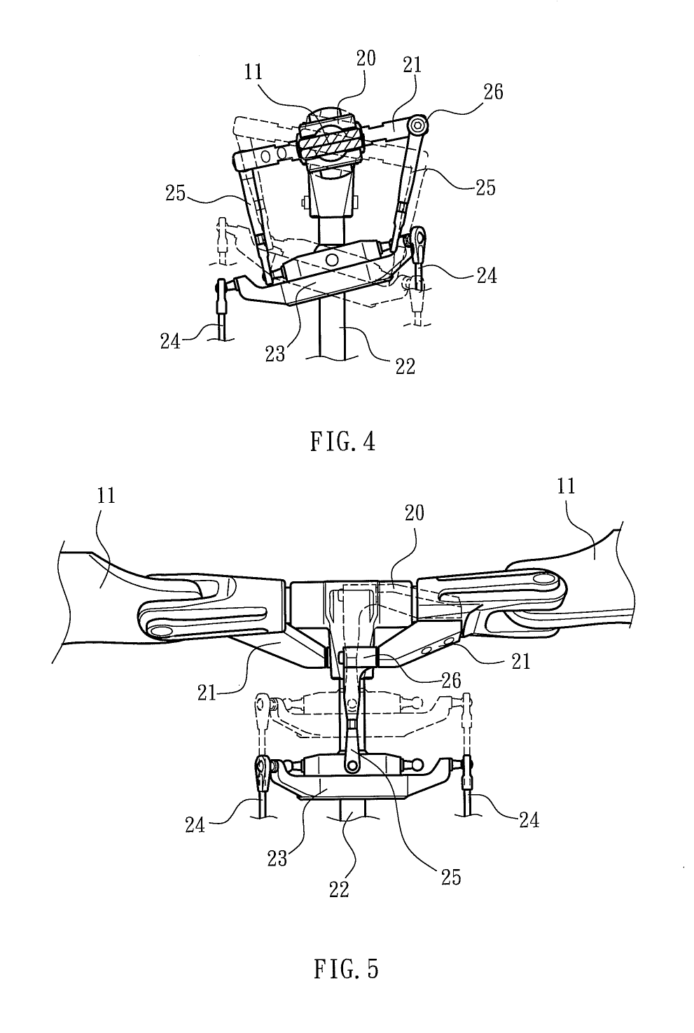

Referring to FIG. 2 through FIG. 5, the present invention comprises a main propeller clamping seat 20, a driving axle 22, and a swashplate 23. The driving axle 22 is connected with the main propeller clamping seat 20. The swashplate 23 is fitted on the driving axle 22. The swashplate 23 is connected with main control rods 24, so that the swashplate 23 can be moved up and down and tilted. The main propeller clamping seat 20 comprises a pair of connection blocks 21 at two ends thereof. The swashplate 23 comprises a pair of link rods 25 which are connected with the pair of connection blocks 21 of the main propeller clamping seat 20. Each link rod 25 has a pivot axle 26 and an axle bolt 27. The axle bolt 27 is inserted through the pivot axle 26 and connected to the relative connection block 21.

The effects and advantages of the present invention are as follows:

1. The main control rods 24 are connected to the motor. Each main control rod 24 can be moved up and down, namely, the swashplate 23 can be moved up and down and tilted. Through the link rods 25 and the connection blocks 21, the main propeller clamping seat 20 can be turned an angle for the wings 11 to be tilted an angle.

2. The swashplate 23 drives the main propeller clamping seat 20 through the link rods 25, forming “direct transmission”, so the transmission is quicker and more precise. Besides, there are fewer parts required to lower the cost and failure rate.

3. The pivot axle 26 and the connection block 21 are connected between the link rod 25 and the main propeller clamping seat 20, which are endurable and stable for transmission.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A transmission structure of a main propeller clamping seat and a swashplate of a remote-controlled helicopter, the main propeller clamping seat being connected with a driving axle, the swashplate being fitted on the driving axle, the swashplate being connected with main control rods for the swashplate to be moved up and down and tilted, the main propeller clamping seat comprising a pair of connection blocks at two ends thereof, the swashplate comprising a pair of link rods which are connected with the pair of connection blocks of the main propeller clamping seat, the pair of link rods each having a pivot axle and an axle bolt, the axle bolt being inserted through the pivot axle and connected to the relative connection block, thereby, the main propeller clamping seat being able to be turned an angle through the link rods when the swashplate is moved up and down and tilted.
